(19) United States
(12) Patent Application Publication
(10) Pub. No.: US 2022/0412041 A1
(43) Pub. Date: Dec. 29, 2022

(54) WORK MACHINE AND CONTROL METHOD FOR WORK MACHINE

(71) Applicant: KOMATSU LTD., Minato-ku, Tokyo (JP)

(72) Inventors: Tomoki KONDA, Minato-ku, Tokyo (JP); Koji KUSAKA, Minato-ku, Tokyo (JP)

(73) Assignee: KOMATSU LTD., Minato-ku, Tokyo (JP)

(21) Appl. No.: 17/778,074

(22) PCT Filed: Nov. 26, 2020
(86) PCT No.: PCT/JP2020/043945

§ 371 Date: May 19, 2022

(30) Foreign Application Priority Data
Dec. 2, 2019 (JP) 2019-218013

(51) Int. Cl. E02F 3/43; E02F 9/22; E02F 9/26

(52) U.S. Cl. CPC E02F 3/437; E02F 9/2235; E02F 9/2246; E02F 9/264

(57) ABSTRACT

A work machine includes a work implement including a bucket and a boom, a revolving body on which the work implement is mounted and that executes a revolving operation, a first operation setting unit that sets a first operation in which movement of the boom in a vertical direction is large and a second operation in which the movement of the boom in the vertical direction is small, the first operation and the second operation being executed in a period from the end of excavation to the start of unloading, a first operation control unit that controls at least one of the work implement or the revolving body to execute the first operation and the second operation, and a load measurement processing unit that measures a load inside the bucket in a period of the second operation.

### TECHNICAL FIELD

The present disclosure relates to a work machine and a control method for a work machine.

### BACKGROUND ART

Measurement of a load inside a bucket in order to know a workload of a work machine is as important as ever.

In this regard, PTL 1 (Japanese Patent Laying-Open No. 2018-48548) proposes a method for estimating a load inside a bucket using information on a pressure sensor of a hydraulic cylinder of a work machine with the load in the bucket kept stationary (PTL 1).

However, in order to estimate the load in the stationary state, it is necessary to secure a period during which the stationary state is kept, so that there is a possibility of making a work cycle period longer.

In this regard, PTL 2 (National Patent Publication No. 2011-516755) proposes a method for estimating a load in a bucket during a revolving operation of a work machine.

### CITATION LIST

### Patent Literatures

PTL 1: Japanese Patent Laying-Open No. 2018-48548

PTL 2: National Patent Publication No. 2011-516755

### SUMMARY OF INVENTION

### Technical Problem

On the other hand, there is a case where pressure on the hydraulic cylinder becomes unstable during the revolving operation of the work machine, and when the load in the bucket is estimated in such a case, the load in the bucket cannot be accurately measured.

It is therefore important to set the operation of the work machine so as to make the pressure on the hydraulic cylinder stable during a period from the end of excavation to the start of unloading.

It is therefore an object of the present disclosure to provide a work machine and a control method for a work machine that allow highly accurate measurement of a load inside a bucket in a period from the end of excavation to the start of unloading.

### SOLUTION TO PROBLEM

A work machine according to an aspect of the present disclosure includes a work implement including a bucket and a boom, a revolving unit on which the work implement is mounted and that executes a revolving operation, a first operation setting unit that sets a first operation in which movement of the boom in a vertical direction is large and a second operation in which the movement of the boom in the vertical direction is small, the first operation and the second operation being executed in a period from the end of excavation to the start of unloading, a first operation control unit that controls at least one of the work implement or the revolving unit to execute the first operation and the second operation, and a load measurement processing unit that measures a load inside the bucket in a period of the second operation.

A control method for a work machine according to an aspect of the present disclosure includes setting a first operation in which movement of a boom of a work implement in a vertical direction is large, the work implement including a bucket and the boom, and a second operation in which the movement of the boom in the vertical direction is small, the first operation and the second operation being executed in a period from an end of excavation to a start of unloading, controlling at least one of the work implement or a revolving unit on which the work implement is mounted and that executes a revolving operation to execute the first operation and the second operation, and measuring a load inside the bucket in a period of the second operation.

### ADVANTAGEOUS EFFECTS OF INVENTION

The work machine and the control method for a work machine according to the present disclosure can measure a load inside the bucket with high accuracy.

### BRIEF DESCRIPTION OF DRAWINGS

FIG. 1 is an external view of a work machine 100 according to a first embodiment.

FIG. 2 is a diagram schematically illustrating the work machine 100 according to the first embodiment.

FIG. 3 is a diagram schematically illustrating a work implement 2 for describing a balance among moments according to the first embodiment.

FIG. 4 is a block diagram for describing a functional configuration of a processing unit 31 of the work machine 100 according to the first embodiment.

FIG. 5 is a conceptual diagram for describing how to set a post-excavation operation of the work machine 100 according to the first embodiment.

FIG. 6 is a diagram for describing a bottom pressure on a boom cylinder 10 according to the first embodiment.

FIG. 7 is a block diagram for describing a functional configuration of a processing unit 31 # of the work machine 100 according to a first modification of the first embodiment.

FIG. 8 is a conceptual diagram for describing how to set a post-excavation operation of the work machine 100 according to the first modification of the first embodiment.

FIG. 9 is a diagram for describing a flow of setting the post-excavation operation by a post-excavation operation setting unit 60 # according to the first modification of the first embodiment.

FIG. 10 is a block diagram for describing a functional configuration of a processing unit 31P of the work machine 100 according to a second modification of the first embodiment.

FIG. 11 is a conceptual diagram for describing how to set a post-excavation operation of the work machine 100 according to the second modification of the first embodiment.

FIG. 12 is a block diagram for describing a functional configuration of a processing unit 31Q of the work machine 100 according to a third modification of the first embodiment.

FIG. 13 is a conceptual diagram for describing how to set a post-unloading operation of the work machine 100 according to the third modification of the first embodiment.

FIG. 14 is a diagram for describing the bottom pressure on the boom cylinder 10 according to the third modification of the first embodiment.

FIG. 15 is a diagram for describing a configuration of a hydraulic system of the work machine 100 according to a second embodiment.

FIG. 16 is a block diagram for describing a functional configuration of a processing unit 131 of the work machine 100 according to the second embodiment.

FIG. 17 is a diagram for describing a guidance screen during measurement according to the second embodiment.

### DESCRIPTION OF EMBODIMENTS

Hereinafter, embodiments will be described with reference to the drawings. In the following description, the same components are denoted by the same reference numerals. Names and functions of such components are also the same. Therefore, detailed descriptions of such components will not be repeated.

### First Embodiment

### Overall Configuration of Work Machine

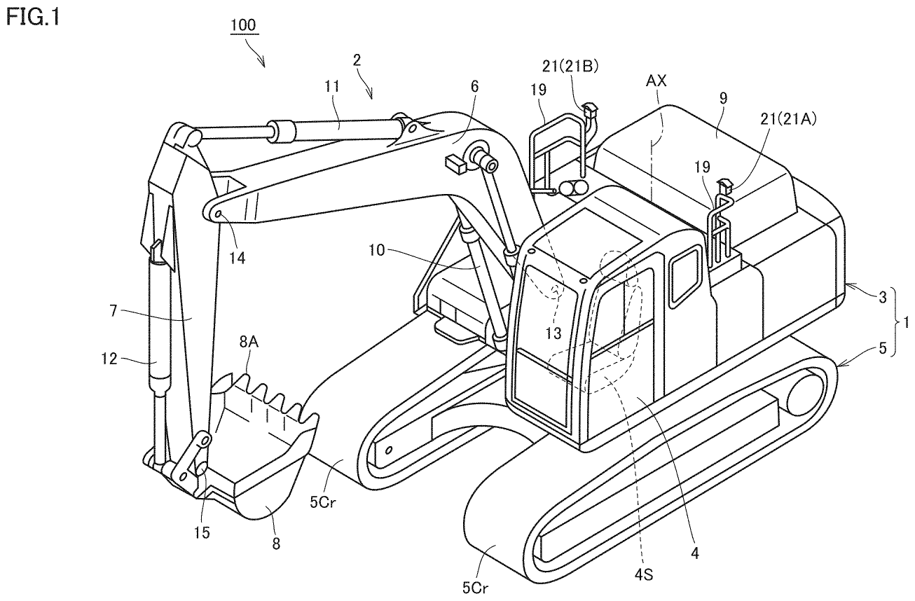

FIG. 1 is an external view of a work machine 100 according to a first embodiment.

As illustrated in FIG. 1, a hydraulic excavator including a work implement 2 that is actuated by hydraulic pressure will be described as an example of a work machine to which the idea of the present disclosure is applicable.

Work machine 100 includes a vehicular body 1 and work implement 2.

Vehicular body 1 includes a revolving unit 3, a cab 4, and a traveling unit 5.

Revolving unit 3 is disposed atop traveling unit 5. Traveling unit 5 supports revolving unit 3. Revolving unit 3 can revolve about a revolving axis AX. Cab 4 is provided with an operator's cab 4S on which an operator sits. The operator operates work machine 100 in cab 4. Traveling unit 5 includes a pair of crawler belts 5Cr. Work machine 100 travels by rotation of crawler belts 5Cr. Traveling unit 5 may include wheels (tires).

A positional relationship among the components relative to the operator seated on operator's cab 4S will be described. A front-rear direction refers to a front-rear direction of the operator seated on operator's cab 4S. A left-right direction refers to a left-right direction relative to the operator seated on operator's cab 4S. The left-right direction coincides with a width direction (vehicle width direction) of the vehicle. A direction facing the front of the operator seated on operator's cab 4S is defined as a forward direction, and a direction opposite to the forward direction is defined as a backward direction. When the operator seated on operator's cab 4S faces the front, the right side and the left side are defined as a right direction and a left direction, respectively.

Revolving unit 3 includes an engine room 9 accommodating an engine, and a counterweight provided at a rear of revolving unit 3. Revolving unit 3 has a handrail 19 provided in front of engine room 9. The engine, a hydraulic pump, and the like are disposed in engine room 9.

Work implement 2 is mounted on and supported by revolving unit 3. Work implement 2 includes a boom 6, an arm 7, a bucket 8, a boom cylinder 10, an arm cylinder 11, and a bucket cylinder 12.

Boom 6 is connected to revolving unit 3 via a boom pin 13. Arm 7 is connected to boom 6 via an arm pin 14. Bucket 8 is connected to arm 7 via a bucket pin 15. Boom cylinder 10 drives boom 6. Arm cylinder 11 drives arm 7. Bucket cylinder 12 drives bucket 8. Boom 6 has a proximal end (boom foot) connected with revolving unit 3. Boom 6 has a distal end (boom top) connected with a proximal end (arm foot) of arm 7. Arm 7 has a distal end (arm top) connected with a proximal end of bucket 8. Boom cylinder 10, arm cylinder 11, and bucket cylinder 12 are each a hydraulic cylinder driven by hydraulic oil.

Boom 6 is pivotable relative to revolving unit 3 about boom pin 13 serving as a center axis. Arm 7 is pivotable relative to boom 6 about arm pin 14 serving as a center axis parallel to boom pin 13. Bucket 8 is pivotable relative to arm 7 about bucket pin 15 serving as a center axis parallel to boom pin 13 and arm pin 14.

Note that boom 6, bucket 8, work implement 2, and revolving unit 3 are examples of a “boom”, a “bucket”, a “work implement”, and a “revolving unit” according to the present disclosure, respectively.

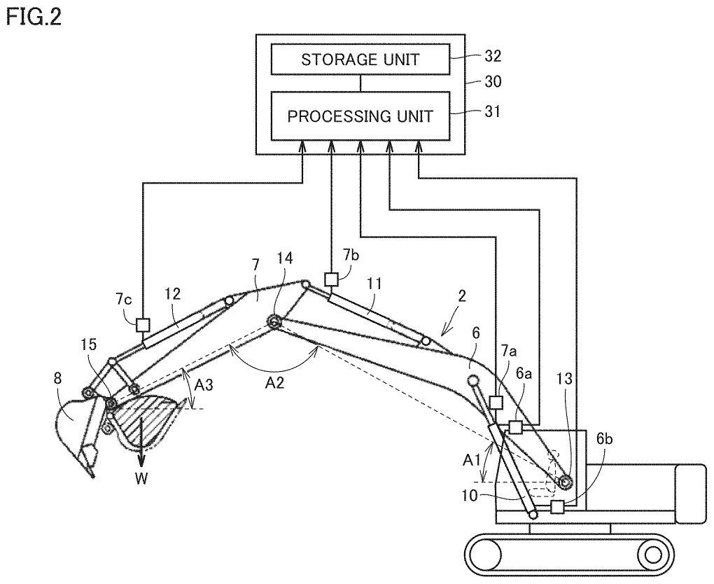

FIG. 2 is a diagram schematically illustrating work machine 100 according to the first embodiment.

FIG. 2 is a side view of work machine 100.

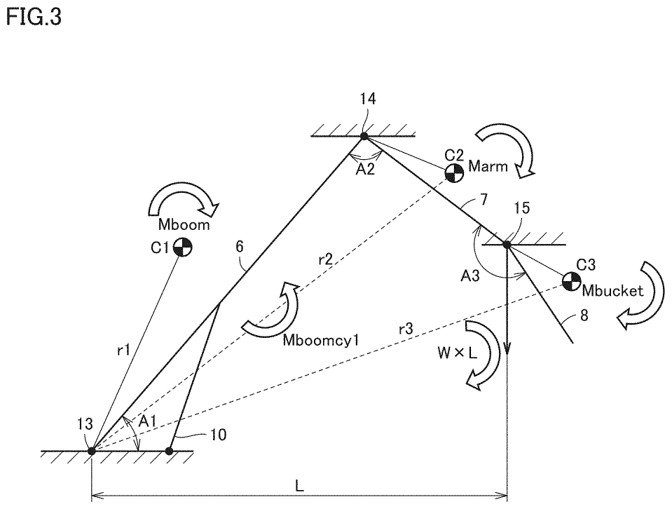

Boom cylinder 10 has a pressure sensor 6a attached to a head side of boom cylinder 10. Pressure sensor 6a is capable of detecting pressure (head pressure) of hydraulic oil in a cylinder head side oil chamber 40A (FIG. 3) of boom cylinder 10. Boom cylinder 10 has a pressure sensor 6b attached to a bottom side of boom cylinder 10. Pressure sensor 6b is capable of detecting pressure (bottom pressure) of hydraulic oil in a cylinder bottom side oil chamber 40B (FIG. 3) of boom cylinder 10.

Stroke sensors (detection units) 7a, 7b, 7c are attached to boom cylinder 10, arm cylinder 11, and bucket cylinder 12, respectively.

Stroke sensors 7a, 7b, 7c and pressure sensors 6a, 6b are each electrically connected to a processing unit 31 of a controller 30.

Processing unit 31 computes a boom angle A1 based on a sensor output of stroke sensor 7a of boom cylinder 10. Processing unit 31 computes an arm angle A2 based on a sensor output of stroke sensor 7b of arm cylinder 11. Processing unit 31 computes a bucket angle A3 based on a sensor output of stroke sensor 7c of bucket cylinder 12. Note that, in this example, a case where boom angle A1, arm angle A2, and bucket angle A3 are computed based on the sensor outputs of stroke sensors 7a, 7b, 7c will be described, but how to compute such angles is not particularly limited to this case, and, for example, boom angle A1, arm angle A2, and bucket angle A3 can be computed using an inertial measurement unit (IMU) attached to boom 6, arm 7, and bucket 8.

As a result, processing unit 31 obtains the head pressure and bottom pressure on boom cylinder 10, boom angle A1, arm angle A2, and bucket angle A3

Controller 30 may include not only processing unit 31 but also a storage unit 32. Storage unit 32 may store weights, shapes, and the like of boom 6, arm 7, and bucket 8.

Such information may be stored in storage unit 32 as default information or may be imported into storage unit 32 from the outside of work machine 100 by operation executed by the operator.

Controller 30 (processing unit 31) has a function of computing a current load (computation load) W inside bucket 8 based on a load on boom cylinder 10. Specifically, controller 30 (processing unit 31) computes the current load (computation load) W inside bucket 8 based on a balance among moments of boom 6, arm 7, and bucket 8. Note that the load on boom cylinder 10 is a so-called axial force obtained from the head pressure and bottom pressure of boom cylinder 10.

### Method for Computing Load W

FIG. 3 is a diagram schematically illustrating work implement 2 for describing a balance among moments according to the first embodiment.

As illustrated in FIG. 3, according to the first embodiment, current load W inside bucket 8 is detected based on a balance among moments about boom pin 13. Herein, the balance among the moments about boom pin 13 is expressed by the following equation (1).

Mboomcyl=Mboom+Marm+Mbucket+W*L (1).

In the equation (1), Mboomcyl denotes a moment about boom pin 13 of boom cylinder 10. Mboom denotes a moment about boom pin 13 of boom 6. Marm denotes a moment about boom pin 13 of arm 7. Mbucket denotes a moment about boom pin 13 of bucket 8. W denotes a current load inside bucket 8. L denotes a horizontal distance from boom pin 13 to bucket pin 15 (a part where bucket 8 is supported by arm 7).

Mboomcyl is computed from a load (the head pressure and the bottom pressure) on boom cylinder 10.

Mboom is computed from a product of a distance r1 between a position of a center of gravity C1 of boom 6 and boom pin 13 and a weight M1 of boom 6 (r1*M1) The position of center of gravity C1 of boom 6 is computed from boom angle A1 and the like. Weight M1 of boom 6 and the like are stored in storage unit 32.

Marm is computed from a product of a distance r2 between a position of a center of gravity C2 of arm 7 and boom pin 13 and a weight M2 of arm 7 (r2*M2). The position of center of gravity C2 of arm 7 is computed from arm angle A2 and the like. Weight M2 of arm 7 and the like are stored in storage unit 32.

Mbucket is computed from a product of a distance r3 between a position of a center of gravity C3 of bucket 8 and boom pin 13 and a weight M3 of bucket 8 (r3*M3). The position of center of gravity C3 of the bucket is computed from bucket angle A3 and the like. Weight M3 of bucket 8 and the like are stored in storage unit 32.

Meanwhile, pressure sensor 6a detects the head pressure on boom cylinder 10. Pressure sensor 6b detects the bottom pressure on boom cylinder 10. Moment Mboomcyl about boom pin 13 of boom cylinder 10 is computed by controller 30 or the like based on the head pressure and bottom pressure on boom cylinder 10.

A horizontal distance L from boom pin 13 to bucket pin 15 is computed by controller 30 or the like based on boom angle A1 and arm angle A2 thus computed, a length of boom 6, and a length of arm 7.

Current load W inside bucket 8 is computed by controller 30 or the like from the above equation (1) into which moments Mboomcyl, Mboom, Marm, Mbucket, and distance L computed as described above are substituted.

As described above, load W is computed from the displacement amount, the head pressure, the bottom pressure, and the like of each of cylinders 10, 11, 12.

### Functional Configuration of Processing Unit 31

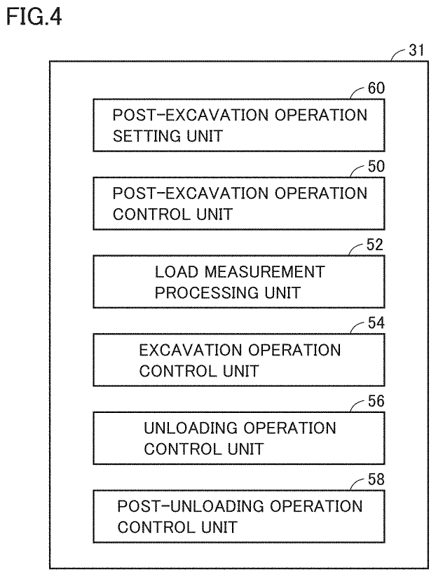

FIG. 4 is a block diagram for describing a functional configuration of processing unit 31 of work machine 100 according to the first embodiment.

As illustrated in FIG. 4, processing unit 31 of work machine 100 according to the first embodiment can compute boom angle A1, arm angle A2, and bucket angle A3 based on the displacement amount of each of cylinder 10, 11, 12 as described above and identify the positions of boom 6, arm 7, and bucket 8 based on boom angle A1, arm angle A2, and bucket angle A3 thus computed, thereby allowing automatic control. In this respect, processing unit 31 executes automatic control processing of repeatedly executing a series of operations including an excavation operation, a post-excavation revolving operation, an unloading operation, and a post-unloading revolving operation.

Processing unit 31 includes a post-excavation operation control unit 50 that controls an operation in a period from the end of excavation to the start of unloading including the revolving operation, a load measurement processing unit 52 that measures a load inside bucket 8, an excavation operation control unit 54 that controls the excavation operation, an unloading operation control unit 56 that controls the unloading operation, a post-unloading operation control unit 58 that controls an operation in a period from the end of unloading to the start of excavation including the revolving operation, and a post-excavation operation setting unit 60 that sets a post-excavation operation.

Excavation operation control unit 54 controls work implement 2 to execute the excavation operation of excavating dirt and the like as an excavation object using bucket 8. Excavation operation control unit 54 sets an opening surface of bucket 8 in the horizontal direction or a direction close to the horizontal direction in order to stably hold dirt and the like during the excavation operation of bucket 8.

Post-excavation operation setting unit 60 sets an operation of moving dirt and the like held in bucket 8 during the excavation operation to an unloading position by control of at least one of the revolving operation (post-excavation revolving operation) of revolving unit 3 or work implement 2, the operation being executed in the period from the end of excavation to the start of unloading.

Post-excavation operation setting unit 60 sets a first operation in which the movement of boom 6 in the vertical direction is large and a second operation in which the movement of the boom 6 in the vertical direction is small, the first operation and the second operation being executed in the period from the end of excavation to the start of unloading.

Post-excavation operation control unit 50 executes the first operation and the second operation set by post-excavation operation setting unit 60 in the period from the end of excavation to the start of unloading.

Post-excavation operation control unit 50 moves the dirt and the like held in bucket 8 by the excavation operation to the unloading position by control of at least one of the revolving operation (post-excavation revolving operation) of revolving unit 3 or work implement 2. Post-excavation operation control unit 50 executes the first operation in which the movement of boom 6 in the vertical direction is large and the second operation in which the movement of boom 6 in the vertical direction is small.

After the post-excavation revolving operation, unloading operation control unit 56 controls work implement 2 to execute the unloading operation of unloading the dirt and the like held in bucket 8 into a bed of a dump truck.

Post-unloading operation control unit 58 moves bucket 8 that become empty after the unloading operation to an excavation position by the revolving operation (post-unloading revolving operation) of revolving unit 3 in the period from the end of unloading to the start of excavation.

Excavation operation control unit 54 controls work implement 2 again to execute the excavation operation of excavating dirt and the like that is an excavation object using bucket 8. The subsequent operations are the same as described above and are repeatedly executed.

Load measurement processing unit 52 measures a load inside bucket 8 in the predetermined period from the end of excavation to the start of unloading. Load measurement processing unit 52 measures the load inside bucket 8 in the period of the second operation that is executed in the period from the end of excavation to the start of unloading.

Note that post-excavation operation control unit 50, load measurement processing unit 52, and post-excavation operation setting unit 60 are examples of a “first operation control unit”, a “load measurement processing unit”, and a “first operation setting unit” according to the present disclosure, respectively.

### Setting of Post-Excavation Operation

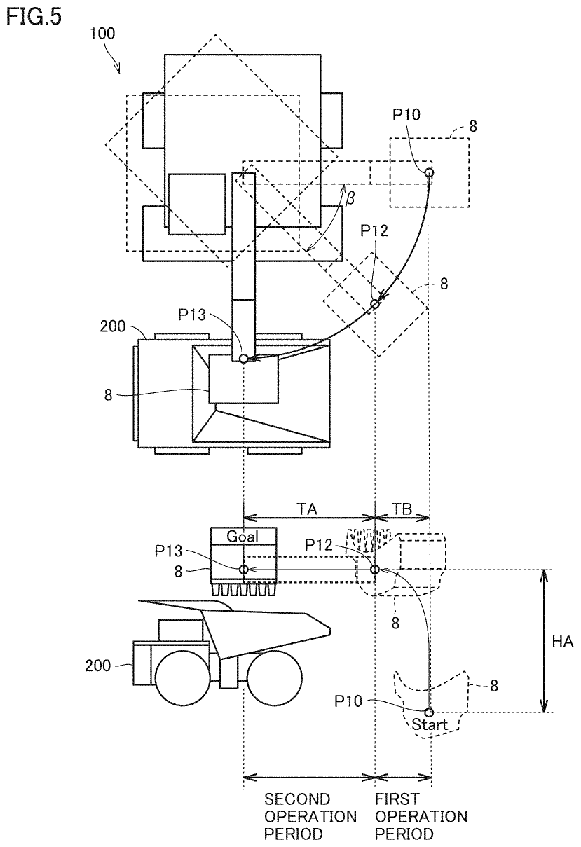

FIG. 5 is a conceptual diagram for describing how to set the post-excavation operation of work machine 100 according to the first embodiment.

As illustrated in FIG. 5, work machine 100 moves bucket 8 to the unloading position by the post-excavation operation. Here, a dump truck 200 is present, and work machine 100 unloads dirt and the like held in bucket 8 into a bed of dump truck 200.

A point P10 is an excavation end point after the excavation operation and is also a revolving start point (Start) at which the revolving operation is started. A point P13 is a revolving end point (Goal) at which the revolving operation is ended. Points P10 and P13 are three-dimensional coordinates and prestored in storage unit 32.

Post-excavation operation setting unit 60 sets the first operation in which the movement of boom 6 in the vertical direction is large and the second operation in which the movement of the boom 6 in the vertical direction is small, the first operation and the second operation being executed in the period from the end of excavation to the start of unloading.

For example, post-excavation operation setting unit 60 sets the first operation of raising bucket 8 from the revolving start point while executing the revolving operation to a height at which unloading is started so as for bucket 8 not to come into contact with the bed of dump truck 200 and the second operation of revolving bucket 8 to the revolving end point after bucket 8 is set at the height at which unloading is started.

A point P12 is a point where the revolving operation is switched from the first operation to the second operation. In this example, load measurement processing unit 52 executes processing of measuring a load inside bucket 8 in the period of the second operation.

Post-excavation operation setting unit 60 computes point P12 based on point P10 and point P13 and sets a section from point P10 to point P12 as the first operation and a section from point P12 to point P13 as the second operation.

Specifically, post-excavation operation setting unit 60 computes a target bucket height HA to which bucket 8 is raised based on information on point P10 and point P13.

Post-excavation operation setting unit 60 computes a set period TB in which bucket 8 is raised to target bucket height HA based on a set speed in the vertical direction that is a default value of work implement 2. Storage unit 32 prestores a speed at which boom 6 and arm 7 are actuated to raise or lower bucket 8 as the set speed in the vertical direction that is a default value of work implement 2. Storage unit 32 further prestores a revolving speed.

Post-excavation operation setting unit 60 computes point P12 based on set period TB and the revolving speed.

Point P12 is computed as a position that is higher than point P10 by target bucket height HA and a position after the revolving operation about the center axis of revolving unit 3 from point P10 by a revolving angle β based on set period TB and the revolving speed.

Post-excavation operation setting unit 60 sets setting period TB in which bucket 8 moves from point P10 to point P12 as the first operation of setting the height of bucket 8 while controlling revolving unit 3 and work implement 2 to execute the revolving operation.

Post-excavation operation setting unit 60 sets a setting period TA in which bucket 8 moves from a point P12 to point P13 as the second operation of controlling revolving unit 3 only to execute the revolving operation.

In this example, load measurement processing unit 52 measures a load inside bucket 8 in the period of the second operation. Period TA is a measurable period in which load measurement processing unit 52 is allowed to measure the load inside bucket 8.

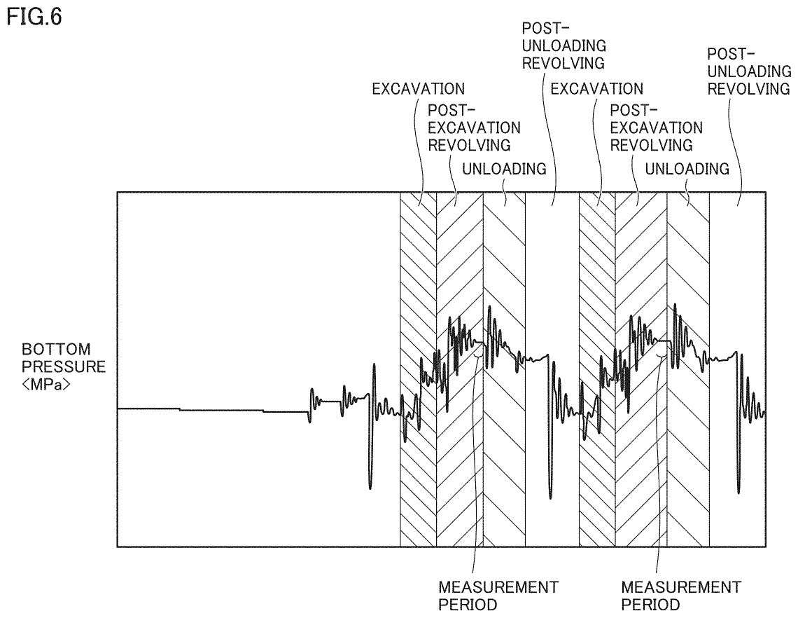

FIG. 6 is a diagram for describing the bottom pressure on boom cylinder 10 according to the first embodiment.

As illustrated in FIG. 6, a case of the execution of automatic control processing of repeatedly executing a series of operations including the excavation operation, the post-excavation revolving operation, the unloading operation, and the post-unloading revolving operation is illustrated. A state where the bottom pressure fluctuates with the movement of boom 6 in operation is illustrated.

The period from the end of excavation to the start of unloading includes the first operation in which the movement of boom 6 in the vertical direction is large and the second operation in which the movement of the boom 6 in the vertical direction is small. In the second operation, the movement of boom 6 in the vertical direction is small, so that the bottom pressure during measurement is stable. It is therefore possible to execute measurement processing with high accuracy because the measurement of a load inside bucket 8 is executed in the period of the second operation period in which the bottom pressure is stable. Although the state of the bottom pressure on boom cylinder 10 has been described in this example, the same applies to the state of the head pressure on boom cylinder 10.

Load measurement processing unit 52 can execute processing of measuring a load inside bucket 8 when bucket 8 reaches point P12.

The closer to the start of unloading, that is, the closer to the end of measurable period TA, the more stable the bottom pressure on the boom cylinder is, so that highly accurate measurement is possible. Therefore, when bucket 8 reaches a predetermined position close to the end of measurable period TA, the processing of measuring a load inside bucket 8 may be executed.

Further, load measurement processing unit 52 may execute the processing of measuring a load inside bucket 8 when an amount of change in the bottom pressure on boom cylinder 10 detected by pressure sensor 6b becomes less than or equal to a predetermined threshold. Note that, using pressure sensor 6a rather than pressure sensor 6b, when an amount of change in the head pressure on boom cylinder 10 becomes less than or equal to the predetermined threshold, the processing of measuring a load inside bucket 8 may be executed.

Although the case where load measurement processing unit 52 executes the processing of measuring a load inside bucket 8 when bucket 8 reaches point P12 has been described, the processing of measuring a load inside bucket 8 may be executed not only when bucket 8 reaches the predetermined position but also when the height of bucket 8 becomes greater than or equal to a predetermined value. Specifically, load measurement processing unit 52 may execute the processing of measuring a load inside bucket 8 when bucket 8 is raised from point P10 by target bucket height HA.

Note that the case where post-excavation operation setting unit 60 sets the first operation and the second operation so as to cause the first operation of controlling work implement 2 and revolving unit 3 to raise bucket 8 from the revolving start point and set bucket 8 to the height at which unloading is started and the second operation of controlling revolving unit 3 only to be executed in this order in the period from the end of excavation to the start of unloading, but how to set the first operation and the second operation is not particularly limited to this case. For example, post-excavation operation setting unit 60 may set the first operation and the second operation so as to cause the second operation of controlling revolving unit 3 only and the first operation of controlling work implement 2 and revolving unit 3 to set bucket 8 to the height at which unloading is started to be executed in this order in the period from the end of excavation to the start of unloading.

### First Modification

In the first embodiment described above, the case where load measurement processing unit 52 executes the processing of measuring a load inside bucket 8 in the period of the second operation in which the movement of the boom 6 in the vertical direction is small in the period from the end of excavation to the start of unloading has been described.

In this regard, in order to execute measurement with high accuracy, it is desirable that measurable period TA be longer than or equal to the predetermined period.

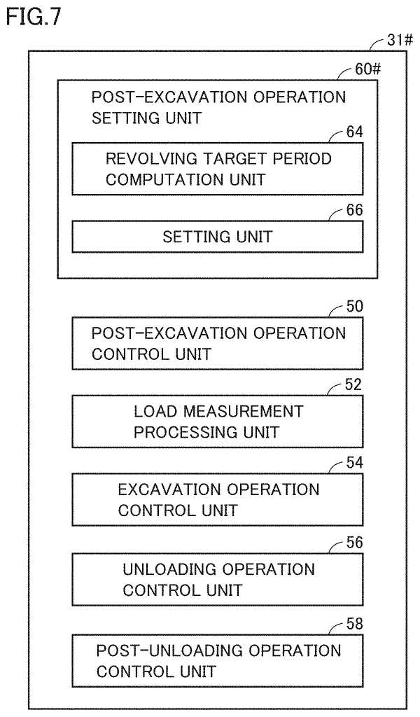

FIG. 7 is a block diagram for describing a functional configuration of a processing unit 31 # of work machine 100 according to a first modification of the first embodiment.

With reference to FIG. 7, processing unit 31 # is different from processing unit 31 described with reference to FIG. 4 in that post-excavation operation setting unit 60 is replaced with a post-excavation operation setting unit 60 #. The other configurations are the same as described with reference to FIG. 4, so that no detailed description of such configurations will be given below.

Post-excavation operation setting unit 60 # includes a revolving target period computation unit 64 and a setting unit 66.

Revolving target period computation unit 64 computes a first revolving target period of revolving unit 3 based on the revolving start point and revolving end point of revolving unit 3 and the revolving speed of revolving unit 3.

Setting unit 66 determines whether the first revolving target period is longer than or equal to a predetermined period. When the first revolving target period is longer than or equal to the predetermined period, setting unit 66 sets the first and second operations so as to cause the second operation to be executed at least during the predetermined period or longer to measure a load inside bucket 8. When the first revolving target period is not longer than or equal to the predetermined period, setting unit 66 sets the first and second operations so as to cause the second operation to be executed during the predetermined period or longer to measure a load inside bucket 8.

Post-excavation operation setting unit 60 # computes the first revolving target period of revolving unit 3 based on the revolving start point and revolving end point of revolving unit 3 and the revolving speed of revolving unit 3. Post-excavation operation setting unit 60 # determines the first revolving target period is longer than or equal to the predetermined period. When the first revolving target period is longer than or equal to the predetermined period, post-excavation operation setting unit 60 # sets the first and second operations so as to cause the second operation to be executed at least during the predetermined period or longer to measure a load inside bucket 8.

### Setting of Post-Excavation Operation

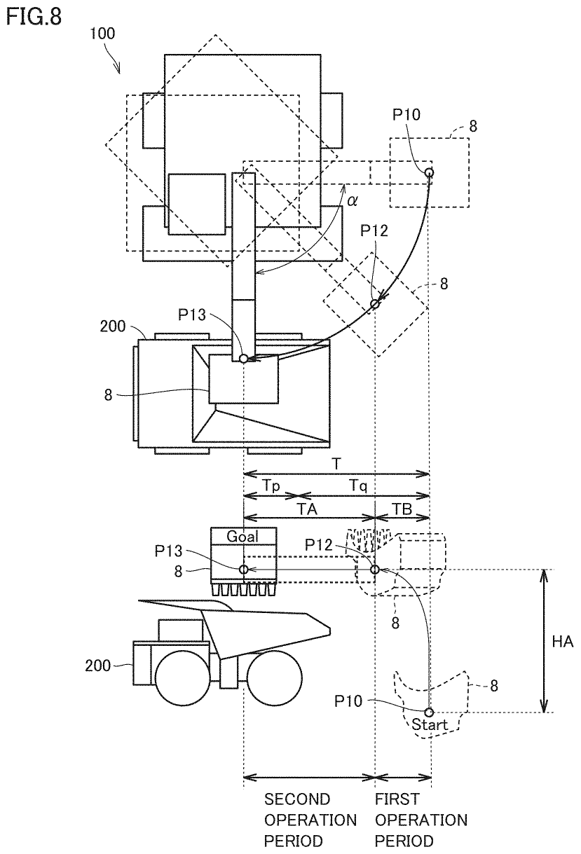

FIG. 8 is a conceptual diagram for describing how to set the post-excavation operation of work machine 100 according to the first modification of the first embodiment.

As illustrated in FIG. 8, the concept is basically the same as described with reference to FIG. 5.

A case where work machine 100 moves bucket 8 to the unloading position by the post-excavation operation is illustrated. Here, dump truck 200 is present, and work machine 100 unloads dirt and the like held in bucket 8 into the bed of dump truck 200.

For example, post-excavation operation setting unit 60 # sets a first operation of raising bucket 8 from the revolving start point to the height at which unloading is started so as for bucket 8 not to come into contact with the bed of dump truck 200 and a second operation of revolving bucket 8 to the revolving end point after bucket 8 is set at the height at which unloading is started.

Revolving target period computation unit 64 computes revolving angle α based on point P10, point P13, and the center axis of revolving unit 3.

Revolving target period computation unit 64 computes a first revolving target period T during which revolving unit 3 is turned from the revolving start point to the revolving end point based on revolving angle a and the revolving speed.

Setting unit 66 determines whether first revolving target period T is longer than or equal to a predetermined period Tp. When first revolving target period T is longer than or equal to predetermined period Tp, setting unit 66 sets the first and second operations so as to cause the second operation to be executed at least during predetermined period Tp or longer to measure a load inside bucket 8. When first revolving target period T is not longer than or equal to predetermined period Tp, setting unit 66 sets the first and second operations so as to cause the second operation to be executed during predetermined period Tp or longer to measure a load inside bucket 8.

In this example, a case where first revolving target period T is longer than or equal to predetermined period Tp will be described as an example.

Setting unit 66 sets, using a remaining period Tq obtained by subtracting predetermined period Tp from first revolving target period T as an example, the first operation of raising bucket 8 from the revolving start point while executing the revolving operation so as for bucket 8 not to come into contact with the bed of dump truck 200 and efficiently setting bucket 8 to the height at which unloading is started.

In this example, setting unit 66 computes target bucket height HA to which bucket 8 is raised based on the information on point P10 and point P13.

Setting unit 66 computes set period TB in which bucket 8 is raised by target bucket height HA based on the set speed in the vertical direction that is a default value of work implement 2. Storage unit 32 prestores a speed at which boom 6 and arm 7 are actuated to raise or lower bucket 8 as the set speed in the vertical direction that is a default value of work implement 2.

In this example, a case where setting unit 66 compares period Tq with set period TB, and period Tq is longer than or equal to set period TB will be described.

Setting unit 66 sets set period TB in period Tq as a period during which the first operation of controlling revolving unit 3 and work implement 2 to set the height of bucket 8 while executing the revolving operation is executed.

Then, setting unit 66 sets period TA obtained by subtracting setting period TB from first revolving target period T as a period during which the second operation of controlling revolving unit 3 only is executed.

In this example, load measurement processing unit 52 measures a load inside bucket 8 in the period of the second operation. Period TA is a measurable period in which load measurement processing unit 52 is allowed to measure the load inside bucket 8.

In this example, setting unit 66 sets the first and second operations so as to always ensure the execution of the second operation during predetermined period Tp in the period from the end of excavation to the start of unloading. Predetermined period Tp is provided to acquire a plurality of sampling points such as the displacement amount, head pressure, and bottom pressure of each of cylinders 10, 11, 12, thereby allowing load measurement processing unit 52 to measure a load with high accuracy.

Load measurement processing unit 52 can acquire a sufficient number of sampling points used for measuring a load with high accuracy when measurable period TA is longer than or equal to predetermined period Tp.

Since load measurement processing unit 52 executes the processing of measuring a load inside bucket 8 in the period of the second operation in which the pressure on a hydraulic cylinder is stable due to small vertical movement of boom 6, the measurement processing can be executed with high accuracy.

Note that the above-described setting of the first and second operations made by setting unit 66 is an example.

For example, setting unit 66 can set the first and second operations so as to ensure the execution of the second operation of controlling revolving unit 3 only during predetermined period Tp from the revolving start point and cause the first operation of raising bucket 8 to the height at which unloading is started while executing the revolving operation using period Tq to be executed in the period from the end of excavation to the start of unloading.

When first revolving target period T is not longer than or equal to predetermined period Tp, setting unit 66 may adjust the revolving speed so as to ensure the execution of the second operation during predetermined period Tp, for example. For example, the first and second operations may be set by decreasing the revolving speed to make first revolving target period T longer and ensure the execution of the second operation during predetermined period Tp or longer.

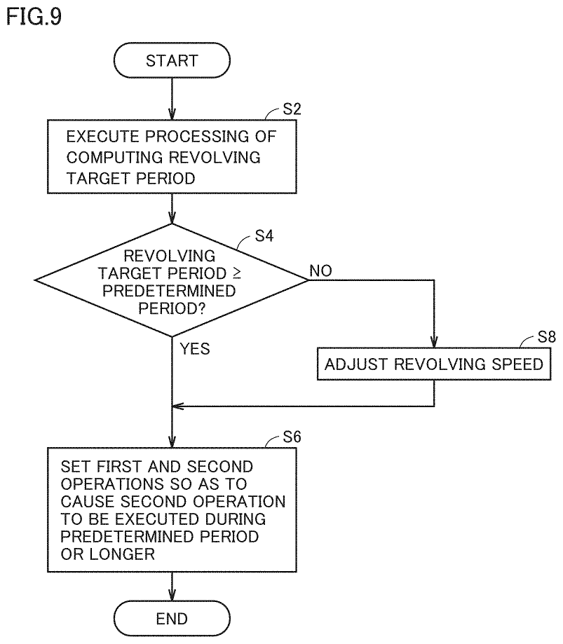

FIG. 9 is a diagram for describing a flow of setting the post-excavation operation by post-excavation operation setting unit 60 # according to the first modification of the first embodiment.

With reference to FIG. 9, post-excavation operation setting unit 60 # executes processing of computing the revolving target period (step S2). Revolving target period computation unit 64 computes revolving angle α based on point P10 that is the revolving start point, point P13 that is the revolving end point, and the center axis of revolving unit 3. Revolving target period computation unit 64 computes first revolving target period T during which revolving unit 3 is turned based on revolving angle a and the revolving speed.

Next, post-excavation operation setting unit 60 # determines whether the first revolving target period is longer than or equal to the predetermined period (step S4). Setting unit 66 determines whether first revolving target period T is longer than or equal to predetermined period Tp.

Next, when determining that the first revolving target period is longer than or equal to the predetermined period (YES in step S4), post-excavation operation setting unit 60 # sets the first and second operations so as to cause the second operation to be executed during the predetermined period or longer (step S6). Then, the processing is brought to an end (END). Setting unit 66 sets the first and second operations so as to always ensure the execution of the second operation during predetermined period Tp in the period from the end of excavation to the start of unloading.

On the other hand, when determining that the first revolving target period is not longer than or equal to the predetermined period (NO in step S4), post-excavation operation setting unit 60 # adjusts the revolving speed (step S8). Then, the processing proceeds to step S6, and post-excavation operation setting unit 60 # sets the first and second operations so as to cause the second operation to be executed during the predetermined period or longer.

Setting unit 66 adjusts the set revolving speed of revolving unit 3 to make the set revolving speed lower. It is therefore possible to make first revolving target period T longer based on the revolving speed thus adjusted. As described above, setting unit 66 sets the first and second operations so as to always ensure the execution of the second operation during predetermined period Tp in the period from the end of excavation to the start of unloading.

Therefore, the measurable period longer than or equal to predetermined period Tp can be secured, so that load measurement processing unit 52 can acquire a sufficient number of sampling points used for measuring a load. This in turn allows load measurement processing unit 52 to execute the measurement processing with high accuracy.

Note that the closer to the start of unloading, that is, the closer to the end of the measurable period, the more stable the bottom pressure on the boom cylinder is, so that highly accurate measurement is possible. Therefore, data during the predetermined period close to the end of the measurable period is acquired, and then the measurement of a load inside bucket 8 may be executed.

Specifically, load measurement processing unit 52 may acquire data during the predetermined period before the start of unloading using a start timing of unloading as a trigger and execute processing of measuring a load inside bucket 8.

### Second Modification

In the first modification of the first embodiment, with reference to FIG. 8, the case where period Tq is compared with set period TB, and period Tq is longer than or equal to set period TB has been described. On the other hand, period Tq is compared with set period TB, and period TB may be longer than period Tq. In this case, there is a possibility that measurable period TA longer than or equal to predetermined period Tp cannot be secured.

Therefore, in a second modification of the first embodiment, a method for adjusting set period TB will be described.

As an example, setting unit 66 compares period Tq with set period TB, and when period TB is longer than set period Tq, the set speed in the vertical direction that is a default value of work implement 2 is adjusted. Specifically, increasing the ascending speed of boom 6 and arm 7 can shorten set period TB. For example, hydraulic oil allocated to arm cylinder 11 may be fed to boom cylinder 10 to accelerate boom 6. Accelerating boom 6 to increase the ascending speed can shorten set period TB.

Setting unit 66 can set the first and second operations so as to always ensure the execution of the second operation during predetermined period Tp by adjusting the set speed in the vertical direction that a default value of work implement 2 to shorten set period TB during which the first operation is executed in the period from the end of excavation to the start of unloading.

Setting unit 66 may set execution of pre-revolving preparation processing so as to always ensure the execution of the second operation during predetermined period Tp in the period from the end of excavation to the start of unloading.

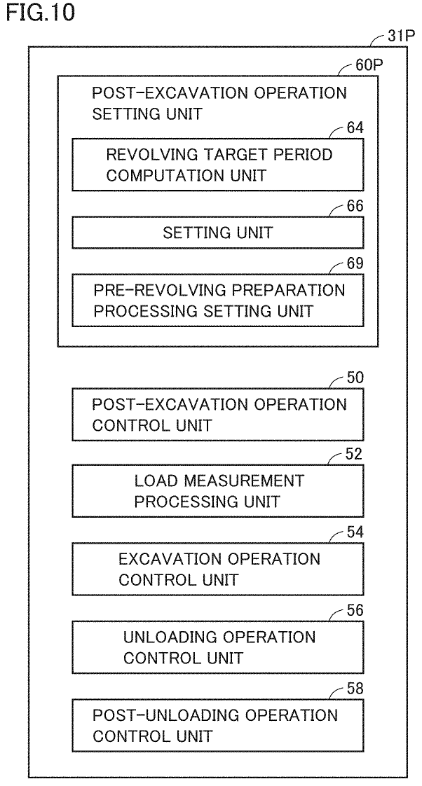

FIG. 10 is a block diagram for describing a functional configuration of a processing unit 31P of work machine 100 according to the second modification of the first embodiment.

With reference to FIG. 10, processing unit 31P is different in configuration from processing unit 31 # illustrated in FIG. 7 in that post-excavation operation setting unit 60 # is replaced with a post-excavation operation setting unit 60P. The other configurations are the same, so that no detailed description of such configurations will be given below.

Post-excavation operation setting unit 60P is different from post-excavation operation setting unit 60 in that a pre-revolving preparation processing setting unit 69 is further provided.

When determining that measurable period TA longer than or equal to predetermined period Tp cannot be secured, post-excavation operation setting unit 60P sets the execution of the pre-revolving preparation processing so as to make measurable period TA longer than or equal to predetermined period Tp.

Specifically, pre-revolving preparation processing setting unit 69 sets the execution of the pre-revolving preparation processing of controlling work implement 2 to adjust the height of bucket 8 before the start of the revolving operation of revolving unit 3 as part of the first operation in accordance with an instruction from setting unit 66.

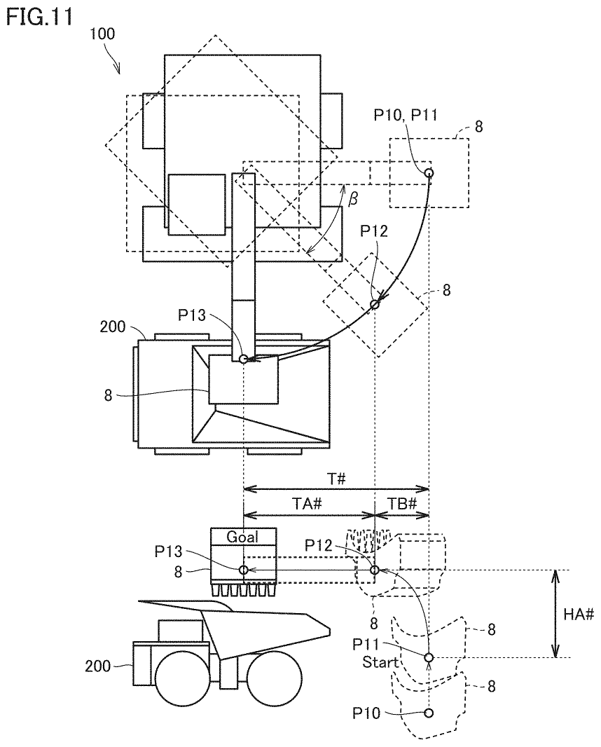

FIG. 11 is a conceptual diagram for describing how to set the post-excavation operation of work machine 100 according to the second modification of the first embodiment.

As illustrated in FIG. 11, a case where work machine 100 moves bucket 8 to the unloading position by the post-excavation operation in the same manner as described in FIG. 8. The revolving start point at which the revolving operation is started is different.

Specifically, point P10 is an excavation end point after the excavation operation. Point P11 is a revolving start point at which the revolving operation is started. Point P13 is a revolving end point at which the revolving operation is ended.

Pre-revolving preparation processing setting unit 69 sets the execution of the pre-revolving preparation processing of controlling work implement 2 to raise bucket 8 from point P10 to point P11.

Post-excavation operation control unit 50 controls work implement 2 to adjust the height of bucket 8 before the start of the revolving operation of revolving unit 3 in accordance with the setting of pre-revolving preparation processing made by pre-revolving preparation processing setting unit 69.

In this example, the revolving start point at which the revolving operation is started is changed from P10 to P11 by the pre-revolving preparation processing. As a result, the target bucket height from revolving start point P11 is adjusted to HA #. This adjustment can shorten set period TB # during which bucket 8 is raised to the height at which unloading is started and set the execution of the pre-revolving preparation processing so as to always ensure the execution of the second operation during predetermined period Tp or longer in the period from the end of excavation to the start of unloading.

According to the second modification of the first embodiment, with the execution of the pre-revolving preparation processing set, the revolving start point at which the revolving operation is started is adjusted so as to always ensure the execution of the second operation during predetermined period Tp or longer, and the processing of measuring a load inside bucket 8 is executed in the period of the second operation, so that the measurement processing can be executed with high accuracy.

### Third Modification

Although the case where the processing of measuring a load inside bucket 8 is executed in the period from the end of excavation to the start of unloading has been described above, the present disclosure is also applicable, in the same manner, to a case where the processing of measuring a load inside bucket 8 is executed in the period from the end of unloading to the start of excavation.

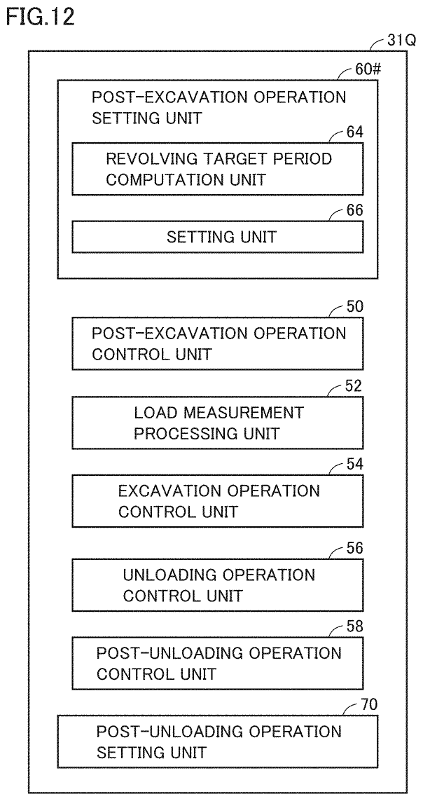

FIG. 12 is a block diagram for describing a functional configuration of a processing unit 31Q of work machine 100 according to a third modification of the first embodiment.

With reference to FIG. 12, processing unit 31Q is different in configuration from processing unit 31 # described with reference to FIG. 7 in that a post-unloading operation setting unit 70 that sets a post-unloading operation is further provided. The other configurations are the same as described with reference to FIG. 7, so that no detailed description of such configurations will be given below.

Post-unloading operation setting unit 70 sets an operation of moving bucket 8 after the unloading operation to the excavation position by control of at least one of the revolving operation (post-unloading revolving operation) of revolving unit 3 or work implement 2 in the period from the end of unloading to the start of excavation.

Post-unloading operation setting unit 70 sets a third operation in which the movement of boom 6 in the vertical direction is large and a fourth operation in which the movement of the boom 6 in the vertical direction is small, the third operation and the fourth operation being executed in the period from the end of unloading to the start of excavation.

Post-unloading operation control unit 58 executes the third operation and the fourth operation set by post-unloading operation setting unit 70 in the period from the end of unloading to the start of excavation.

Post-unloading operation control unit 58 moves bucket 8 after the unloading operation to the excavation position by control of at least one of the revolving operation (post-unloading revolving operation) of revolving unit 3 or work implement 2. Post-unloading operation control unit 58 executes the third operation in which the movement of boom 6 in the vertical direction is large and the fourth operation in which the movement of boom 6 in the vertical direction is small.

Excavation operation control unit 54 controls work implement 2 again to execute the excavation operation of excavating dirt and the like that is an excavation object using bucket 8. The subsequent operations are the same as described above and are repeatedly executed.

Note that post-unloading operation control unit 58 and post-unloading operation setting unit 70 are examples of a “second operation control unit” and a “second operation setting unit” according to the present disclosure, respectively.

### Setting of Post-Unloading Operation

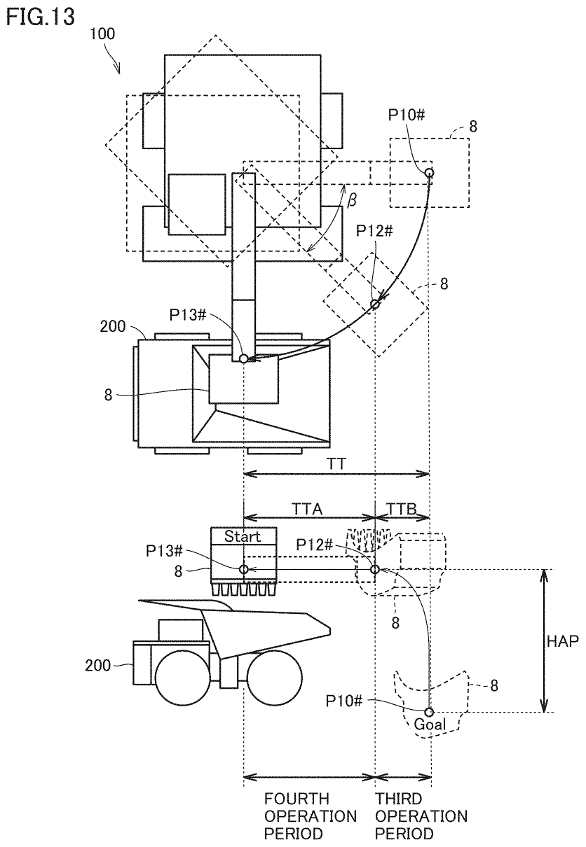

FIG. 13 is a conceptual diagram for describing how to set the post-unloading operation of work machine 100 according to the third modification of the first embodiment.

As illustrated in FIG. 13, work machine 100 moves bucket 8 to the excavation position by the post-unloading operation. Here, dump truck 200 is present, and work machine 100 moves, to the excavation position, bucket 8 from which dirt has been unloaded into a bed of dump truck 200.

A point P13 # is an unloading end point after the unloading operation and is also a revolving start point (Start) at which the revolving operation is started. A point P10 # is a revolving end point (Goal) at which the revolving operation is ended. Points P10 # and P13 # are three-dimensional coordinates and prestored in storage unit 32.

Post-unloading operation setting unit 70 sets a third operation in which the movement of boom 6 in the vertical direction is large and a fourth operation in which the movement of the boom 6 in the vertical direction is small, the third operation and the fourth operation being executed in the period from the end of unloading to the start of excavation.

For example, post-unloading operation setting unit 70 sets the fourth operation of revolving bucket 8 from the revolving start point while maintaining the height of revolving bucket 8 at which unloading is ended so as for bucket 8 not to come into contact with the bed of dump truck 200, and the third operation of lowering bucket 8 from the height at which unloading is ended and setting bucket 8 to the height at which excavation is started.

A point P12 # is a point where the revolving operation is switched from the fourth operation to the third operation. In this example, load measurement processing unit 52 executes the processing of measuring a load inside bucket 8 in the period of the fourth operation.

Post-unloading operation setting unit 70 computes point P12 # based on point P10 # and point P13 # and sets a section from point P13 # to point P12 # as the fourth operation and a section from point P12 # to point P10 # as the third operation.

Specifically, post-unloading operation setting unit 70 computes a target bucket height HAP by which bucket 8 is lowered based on information on point P10 # and point P13 #.

Post-unloading operation setting unit 70 computes a set period TTB during which bucket 8 is lowered by target bucket height HAP based on the set speed in the vertical direction that is a default value of work implement 2. Storage unit 32 prestores a speed at which boom 6 and arm 7 are actuated to raise or lower bucket 8 as the set speed in the vertical direction that is a default value of work implement 2. Storage unit 32 further prestores a revolving speed.

Post-unloading operation setting unit 70 computes point P12 # based on set period TTB and the revolving speed.

Point P12 # is computed as a position that is before reaching point P10 # and after the revolving operation is executed by a revolving angle β based on set period TTB and the revolving speed about the center axis of revolving unit 3, and when bucket 8 is lowered from the height of point P13 # by target bucket height HAP.

Post-unloading operation setting unit 70 sets a setting period TTA during which bucket 8 moves from point P13 # to point P12 # as the fourth operation of controlling revolving unit 3 only to execute the revolving operation.

Post-unloading operation setting unit 70 sets setting period TTB during which bucket 8 moves from point P12 # to point P10 # as the third operation of controlling revolving unit 3 and work implement 2 while executing the revolving operation to set the height of bucket 8.

In this example, load measurement processing unit 52 measures a load inside bucket 8 in the period of the fourth operation. Period TTA is a measurable period in which the load measurement processing unit 52 is allowed to measure the load inside bucket 8.

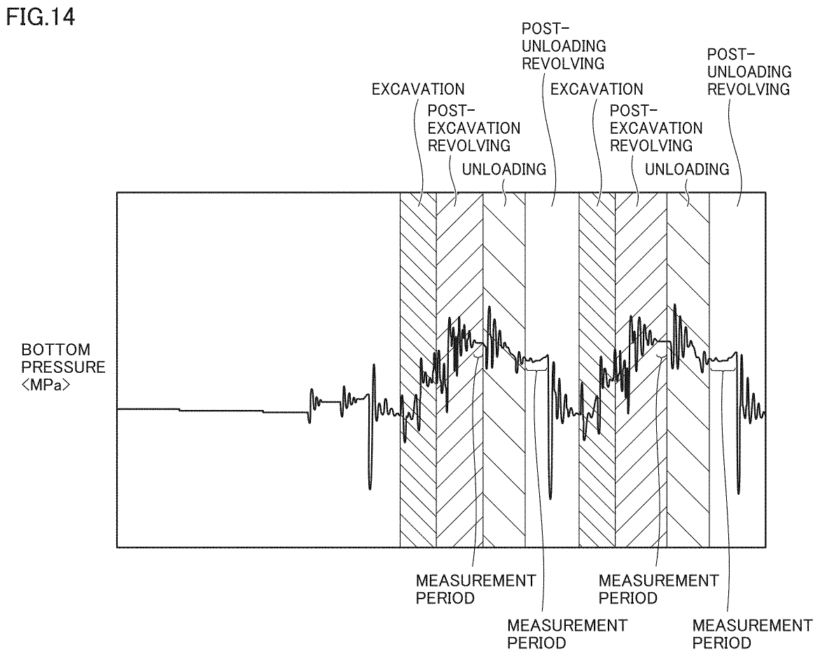

FIG. 14 is a diagram for describing the bottom pressure on boom cylinder 10 according to the third modification of the first embodiment.

As illustrated in FIG. 14, the execution of automatic control processing of repeatedly executing a series of operations including the excavation operation, the post-excavation revolving operation, the unloading operation, and the post-unloading revolving operation is illustrated. A state where the bottom pressure fluctuates with the movement of boom 6 in operation is illustrated.

The period from the end of excavation to the start of unloading includes the first operation in which the movement of boom 6 in the vertical direction is large and the second operation in which the movement of the boom 6 in the vertical direction is small. In the second operation, the movement of boom 6 in the vertical direction is small, so that the bottom pressure during measurement is stable. The processing of measuring a load inside bucket 8 is executed in the period in which the bottom pressure is stable, so that the measurement processing can be executed with high accuracy.

Further, the period from the end of unloading to the start of excavation includes the third operation in which the movement of boom 6 in the vertical direction is large and the fourth operation in which the movement of the boom 6 in the vertical direction is small. In the fourth operation, the movement of boom 6 in the vertical direction is small, so that the bottom pressure is stable during measurement. The processing of measuring a load inside bucket 8 is executed in the period in which the bottom pressure is stable, so that the measurement processing can be executed with high accuracy. Although the state of the bottom pressure on boom cylinder 10 has been described in this example, the same applies to the state of the head pressure on boom cylinder 10.

It is therefore possible to accurately measure a load inside bucket 8 before unloading and a load inside bucket 8 after unloading.

It is possible to accurately measure dirt and the like loaded into the bed of dump truck 200 by computing a difference between a load inside bucket 8 before unloading and a load inside bucket 8 after unloading.

### Second Embodiment

In the above-described embodiment, the method for controlling the movement of boom 6 during the revolving operation to measure a load in the period has been described, but the method is not limited to the period of the revolving operation, and a load may be measured by controlling the movement of boom 6.

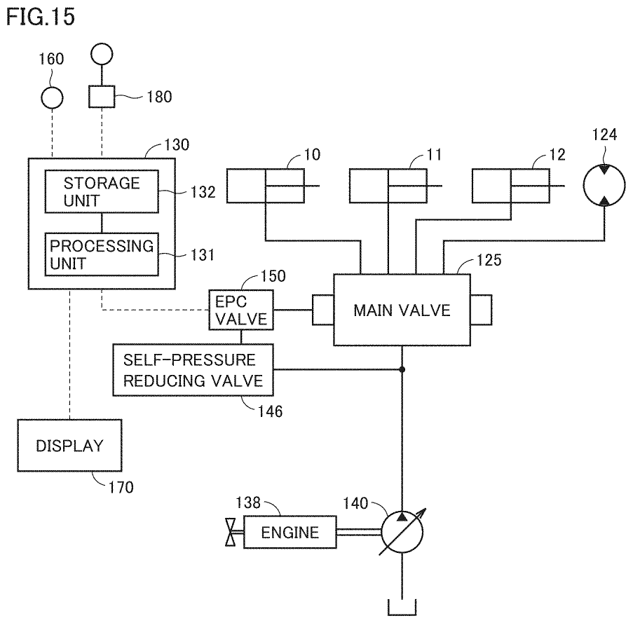

FIG. 15 is a diagram for describing a configuration of a hydraulic system of work machine 100 according to a second embodiment.

With reference to FIG. 15, work machine 100 includes boom cylinder 10 that drives boom 6, arm cylinder 11 that drives arm 7, bucket cylinder 12 that drives bucket 8, a revolving motor 124 that turns revolving unit 3, a controller 130 that controls work machine 100, an engine 138, a hydraulic pump 140, a main valve 125, a self-pressure reducing valve 146, and an EPC valve 150.

Engine 138 is, for example, a diesel engine.

Hydraulic pump 140 is driven by engine 138 to discharge hydraulic oil. Hydraulic pump 140 is a variable displacement hydraulic pump. The hydraulic pump may be a fixed displacement hydraulic pump that changes the discharge amount of hydraulic oil according to an engine speed of engine 138.

Main valve 125 receives the hydraulic oil fed from hydraulic pump 140 to distribute and supply the hydraulic oil to boom cylinder 10, arm cylinder 11, bucket cylinder 12, and revolving motor 124.

Controller 130 outputs a command current to EPC valve 150. EPC valve 150 controls main valve 125 in accordance with the command current from controller 130.

The hydraulic oil output from hydraulic pump 140 is reduced in pressure to constant pressure by self-pressure reducing valve 146 and fed as pilot hydraulic oil.

Controller 130 according to the embodiment includes a processing unit 131 (for example, a central processing unit (CPU)), a storage unit 132, and the like, and executes a program and the like stored in storage unit 132 to control work machine 100.

Work machine 100 further includes an operation apparatus 180 that operates boom 6, a load measurement button 160, and a display 170.

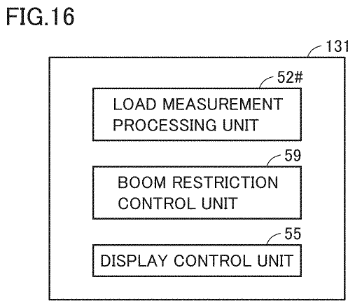

FIG. 16 is a block diagram for describing a functional configuration of processing unit 131 of work machine 100 according to the second embodiment.

As illustrated in FIG. 16, processing unit 131 of work machine 100 according to the second embodiment includes a load measurement processing unit 52 # that measures a load inside bucket 8, a boom restriction control unit 59 that restricts the movement of boom 6, and a display control unit 55 that controls contents to be displayed on display 170.

In this example, load measurement processing unit 52 # measures a load inside bucket 8 in accordance with an operation instruction of load measurement button 160. The measurement method is the same as described in the first embodiment, so that no description of details of the measurement method will be given below.

Boom restriction control unit 59 restricts the movement of boom 6 in accordance with an operation instruction of load measurement button 160.

Specifically, boom restriction control unit 59 disables the input from operation apparatus 180 that operates boom 6 in accordance with an operation instruction of load measurement button 160 during a predetermined period.

This process restricts the movement of boom 6 during the predetermined period.

Load measurement processing unit 52 # measures a load inside bucket 8 in the predetermined period during which the movement of boom 6 is restricted in accordance with an operation instruction of load measurement button 160.

Since the movement of boom 6 in the vertical direction is restricted, the bottom pressure is stable during the measurement. The processing of measuring a load inside bucket 8 is executed in the period in which the bottom pressure is stable, so that the measurement processing can be executed with high accuracy.

Note that, in this example, the case where the input from the operation apparatus 180 that operates boom 6 in accordance with the operation instruction of load measurement button 160 is disabled during the predetermined period has been described, but the command current to EPC valve 150 based on an operation command of boom 6 may be adjusted. Specifically, the movement of boom 6 may be restricted by setting an upper limit of the command current. Alternatively, the output of the command current to EPC valve 150 based on the boom operation command may be delayed. This process causes the processing of measuring a load inside bucket 8 to be executed in a period during which the pressure of boom cylinder 10 is relatively stable due to the restriction on the movement of boom 6 in the vertical direction, so that the measurement processing can be executed with high accuracy.

In the above description, the method for restricting the movement of boom 6 in accordance with the operation instruction of load measurement button 160 has been described, but, instead of forcibly restricting the movement of boom 6, a guidance screen prompting the operator to restrict the movement of boom 6 may be displayed.

Display control unit 55 displays a guidance screen on display 170 in accordance with an operation instruction of load measurement button 160.

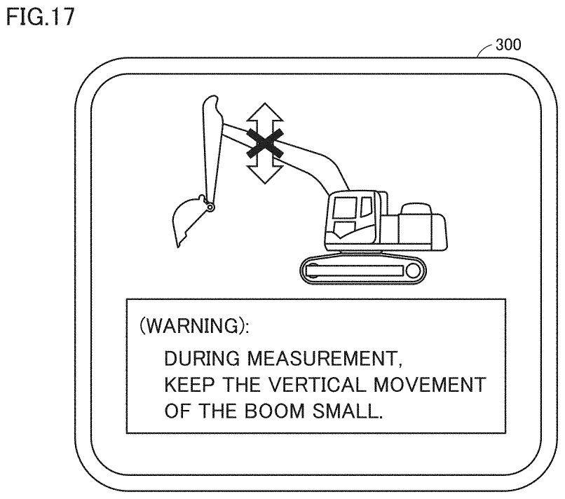

FIG. 17 is a diagram for describing a guidance screen during measurement according to the second embodiment.

With reference to FIG. 17, a guidance screen 300 displayed on display 170 is shown. A message “(WARNING) DURING MEASUREMENT, KEEP THE VERTICAL MOVEMENT OF THE BOOM SMALL.” is displayed on guidance screen 300.

With reference to guidance screen 300, the operator can prompt operation apparatus 180 to operate boom 6.

This process promotes the restriction on the movement of boom 6 in the vertical direction and causes the processing of measuring a load inside bucket 8 to be executed in a period during which the pressure of boom cylinder 10 is relatively stable, so that the measurement processing can be executed with high accuracy.

Note that the above guidance screen may be displayed while forcibly restricting the movement of boom 6.

Further, in the above description, the case where display control unit 55 displays the guidance screen on display 170 in accordance with the operation instruction of load measurement button 160 has been given, but the guidance screen may be displayed on display 170 in accordance with the operation instruction of boom 6 by operation apparatus 180. For example, when an amount of operation of boom 6 by operation apparatus 180 is greater than or equal to a predetermined amount, the guidance screen may be displayed on the assumption that the movement of the boom 6 in the vertical direction is large.

Further, in this example, the case where the guidance screen is displayed using display 170 has been given, but a warning sound may be output using a speaker, for example. For example, the message on guidance screen 300 may be output using a speaker.

In the above-described embodiments, an excavator (backhoe) is given as an example of the work machine, but the present disclosure is applicable not only to an excavator (backhoe) but also to other types of work machines such as a loading excavator, a mechanical, cable-operated excavator, an electric excavator, a wheel loader, and a bucket crane.

Although the embodiments of the present disclosure have been described, it should be understood that the embodiments disclosed herein are illustrative in all respects and not restrictive. The scope of the present disclosure is set forth by the claims, and the present disclosure is intended to include the claims, equivalents of the claims, and all modifications within the scope.

### REFERENCE SIGNS LIST

1: vehicular body, 2: work implement, 3: revolving body, 4: cab, 4S: operator's cab, 5: traveling unit, 5Cr: crawler belts, 6: boom, 6a, 6b: pressure sensor, 7: arm, 7a, 7b, 7c: stroke sensor, 8: bucket, 9: engine room, 10: boom cylinder, 11: arm cylinder, 12: bucket cylinder, 13: boom pin, 14: arm pin, 15: bucket pin, 19: handrail, 30, 130: controller, 31, 31 #, 31P, 31Q, 131: processing unit, 32, 132: storage unit, 50: post-excavation operation control unit, 52: load measurement processing unit, 54: excavation operation control unit, 55: display control unit, 56: unloading operation control unit, 58: post-unloading operation control unit, 59: boom restriction control unit, 60: post-excavation operation setting unit, 64, 72: revolving target period computation unit, 66, 74: setting unit, 69: pre-revolving preparation processing setting unit, 70: post-unloading operation setting unit, 100: work machine, 124: revolving motor, 125: main valve, 138: engine, 140: hydraulic pump, 146: self-pressure reducing valve, 150: EPC valve, 160: load measurement button, 170: display, 180: operation apparatus, 200: dump truck, 300: guidance screen

1. A work machine comprising:
a work implement including a bucket and a boom;
a revolving body on which the work implement is mounted and that executes a revolving operation;
a first operation setting unit that sets a first operation in which movement of the boom in a vertical direction is large and a second operation in which the movement of the boom in the vertical direction is small, the first operation and the second operation being executed in a period from an end of excavation to a start of unloading;
a first operation control unit that controls at least one of the work implement or the revolving body to execute the first operation and the second operation; and
a load measurement processing unit that measures a load inside the bucket in a period of the second operation.

2. The work machine according to claim 1, wherein the first operation setting unit
computes a first revolving target period of the revolving body based on a revolving start point and revolving end point of the revolving body and a revolving speed of the revolving body,
determines whether the first revolving target period is longer than or equal to a predetermined period, and
sets the first and second operations so as to cause, when the first revolving target period is longer than or equal to the predetermined period, the second operation to be executed to measure the load inside the bucket at least during the predetermined period or longer.

3. The work machine according to claim 1, wherein when the first revolving target period is not longer than or equal to the predetermined period, the first operation setting unit adjusts the revolving speed of the revolving body so as to make the first revolving target period longer than or equal to the predetermined period.

4. The work machine according to claim 2, wherein
the first operation setting unit
computes a first setting period in which the bucket is moved to a height at which unloading is started based on a speed of the work implement,
determines whether a first measurable period in which measurement of the load inside the bucket is allowed is longer than or equal to the predetermined period, the first measurable period being obtained by subtracting the first setting period from the first revolving target period, and
when the first measurable period is longer than or equal to the predetermined period, sets the first setting period as an execution period of the first operation and sets the first measurable period as an execution period of the second operation.

5. The work machine according to claim 4, wherein when the first measurable period is not longer than or equal to the predetermined period, the first operation setting unit adjusts an ascending speed of the boom during the first operation so as to make the first measurable period longer than or equal to the predetermined period.

6. The work machine according to claim 4, wherein when the first measurable period is not longer than or equal to the predetermined period, the first operation setting unit sets execution of pre-revolving preparation processing of adjusting a height of the bucket by controlling the work implement before a start of the revolving operation of the revolving body as the first operation so as to make the first measurable period longer than or equal to the predetermined period.

7. The work machine according to claim 1, further comprising:
a second operation setting unit that sets a third operation in which the movement of the boom in the vertical direction is large and a fourth operation in which the movement of the boom in the vertical direction is small, the third operation and the fourth operation being executed in a period from an end of unloading to a start of excavation; and
a second operation control unit that controls at least one of the work implement or the revolving body to execute the third operation and the fourth operation, wherein the second operation setting unit computes a second revolving target period of the revolving body based on a revolving start point and revolving end point of the revolving body and a revolving speed of the revolving body, and
sets the third and fourth operations so as to cause, when the second revolving target period is longer than or equal to the predetermined period, the fourth operation to be executed to measure the load inside the bucket at least during the predetermined period or longer.

8. The work machine according to claim 1, wherein
the work implement includes:
a boom cylinder that drives the boom; and
a sensor that detects pressure on the boom cylinder, and
the load measurement processing unit measures the load inside the bucket when an amount of change in pressure detected by the sensor is less than or equal to a predetermined threshold.

9. The work machine according to claim 1, wherein the load measurement processing unit measures the load inside the bucket when the height of the bucket becomes greater than or equal to a predetermined value.

10. The work machine according to claim 1, wherein the load measurement processing unit measures the load inside the bucket when the bucket passes through a predetermined position.

11. The work machine according to claim 1, wherein the load measurement processing unit measures the load inside the bucket based on information on the predetermined period before unloading based on a time of unloading in the period of the second operation.

12. A control method for a work machine, comprising:
setting a first operation in which movement of a boom of a work implement in a vertical direction is large, the work implement including a bucket and the boom, and a second operation in which the movement of the boom in the vertical direction is small, the first operation and the second operation being executed in a period from an end of excavation to a start of unloading;
controlling at least one of the work implement or a revolving body on which the work implement is mounted and that executes a revolving operation to execute the first operation and the second operation; and
measuring a load inside the bucket in a period of the second operation.
